(19) United States
(12) Patent Application Publication
(10) Pub. No.: US 2024/0030541 A1
(43) Pub. Date: Jan. 25, 2024

(54) LOCK MECHANISM FOR BATTERY PACK, BRACKET ASSEMBLY, BATTERY PACK, ELECTRIC VEHICLE, AND LOCK METHOD FOR BATTERY PACK

(71) Applicants: AULTON NEW ENERGY AUTOMOTIVE TECHNOLOGY GROUP, Guangzhou, Guangdong (CN); SHANGHAI DIANBA NEW ENERGY TECHNOLOGY CO., LTD., Shanghai (CN)

(72) Inventors: Jianping Zhang, Shanghai (CN); Danliang Qiu, Shanghai (CN)

(21) Appl. No.: 17/912,504

(22) PCT Filed: Mar. 17, 2021
(86) PCT No.: PCT/CN2021/081379

§ 371 Date: Apr. 6, 2023

(30) Foreign Application Priority Data
Mar. 17, 2020 (CN) 202010188319.7

(51) Int. Cl. H01M 50/262; H01M 50/249; H01M 50/244; B60K 1/04

(52) U.S. Cl. CPC H01M 50/262; H01M 50/249; H01M 50/244; B60K 1/04; B60K 2001/0438

(57) ABSTRACT

Disclosed are a lock mechanism for a battery pack, a bracket assembly, a battery pack, an electric vehicle and a lock method for a battery pack. The lock mechanism comprises a first unit and a second unit, which are respectively arranged on a side wall of the bracket and a side wall of the battery pack. The first unit comprises a lock seat, which is provided with a locking space; the second unit comprises an extension end; when the battery pack is placed with respect to the bracket, the locking space bears and locks the extension end; and the lock mechanism is provided, above the locking space, with an opening, which faces the battery pack and approaches the battery pack in a horizontal direction, such that the extension end enters the opening in a horizontal direction facing the side wall of the bracket and falls into the locking space.

This application claims the priority of Chinese patent application 2020101883197 with a filing date of Mar. 17, 2020. The contents of the above Chinese patent application are incorporated herein by reference in its entirety.

### TECHNICAL FIELD

The present disclosure relates to a lock mechanism for a battery pack, a bracket assembly, a battery pack, an electric vehicle and a lock method for a battery pack.

### BACKGROUND

The battery settings of existing electric vehicles are generally divided into fixed and replaceable, wherein, the fixed battery is generally fixed on the vehicle, and the vehicle is directly used as a charging object when charging. However, the replaceable battery is generally fixed on a bracket of the vehicle by means of movable installation, wherein the battery can be removed for replacement or charging separately and can be installed on the vehicle again after the replaced battery is charged.

In the prior art, replacement methods of the battery include manual, automatic and other means, and when the battery is installed on the bracket of the vehicle, the bracket needs to lock the battery on the bracket no matter which means is used, which is usually realized by multi-point locking because of the large volume and heavy weight of the battery. For the lock mechanism, how to quickly and conveniently lock or unlock the battery to or from the vehicle bracket is the focus of research and development by existing technicians. The prior art CN109987063U discloses an electric exchange device with a horizontally-assembled-dissembled battery, which is used to load a battery box into a battery compartment, or take out a battery box from a battery compartment, wherein the battery compartment is provided with a locking groove, and the battery box is provided with a locking bolt; when the battery box is installed in the battery compartment, the locking bolt can be locked in the locking groove. The cooperation of the locking bolt and the locking groove makes the battery box be locked in the battery compartment to prevent the battery box from leaving the battery compartment. CN108729760A discloses a locking device and an AGV using the same, wherein the locking device comprises a fixing frame. A lock catch is rotationally assembled on the fixing frame, a push-bearing part driven by a power source module to rotate forward around a lock catch rotating shaft is arranged on the lock catch, and a locking arm extending in the radial direction of the lock catch rotating shaft is further arranged on the lock catch. The locking arm rotates when the lock catch rotates forward and blocks a lock lug on the power source module in the direction away from the lock catch. The locking device further comprises a blocking piece which is in blocking fit with the lock catch to prevent reverse rotating of the lock catch after the lock lug is blocked. The blocking piece is connected with a driving unit capable of being electrically driven and is driven by the driving unit to block and unblock the lock catch. An elastic piece connected with the lock catch is further arranged on the fixing frame and provides elastic force for reverse rotating of the lock catch, and after the blocking piece unblocks the lock catch, the lock catch is driven to rotate reversely, so that blocking of the lock lug is removed. All of the above locking structures have complex structures, the locking and unlocking processes are cumbersome, and both locking stability and efficiency of locking and unlocking cannot be considered simultaneously.

### CONTENT OF THE PRESENT INVENTION

The technical problem to be solved in the present disclosure is to overcome the defects of the complicated process and cumbersome steps of installing a battery pack on a bracket in the prior art, hence providing a lock mechanism for a battery pack, a bracket assembly, a battery pack, an electric vehicle and a lock method for a battery pack.

The present disclosure solves the above technical problems through the following technical schemes:

A lock mechanism for a battery pack, wherein the lock mechanism is arranged on a side wall of a bracket, the lock mechanism is used to unlock or lock the battery pack from or to the bracket, the lock mechanism comprises a lock seat, the lock seat is provided with a locking space, the lock mechanism is used to bear an extension end, when the extension end on the battery pack, the battery pack is placed relative to the bracket, and lock the extension end at the locking space;

the lock mechanism is provided, above the locking space, with an opening which faces the battery pack and approaches the battery pack in a horizontal direction, such that the extension end enters the opening in a horizontal direction facing the side wall of the bracket and falls into the locking space.

The lock mechanism allows the extension end of the battery pack to pass through the opening in the horizontal direction and then fall down into the locking space, and uses the locking space to fix the extension end, so that the battery pack can be fixed relative to the bracket in the process of being placed on the bracket by a battery replacement device such as a stacker, so as to effectively reduce the complexity of the process and the cumbersome steps of installing and fixing the battery pack on the bracket, and also ensure the reliability of the fixation. By setting the lock mechanism on the side wall of the bracket, the battery pack is locked in the process of moving the battery pack towards the bracket, and the shaking of the battery pack on an electric vehicle can be effectively restricted from the horizontal direction, thus improving the stability of the battery pack locking, simplifying, simplifying the locking and unlocking process, and improving the efficiency of battery pack locking and unlocking.

Preferably, the lock mechanism further comprises a movable part, and the movable part is used to lock the extension end after the extension end of the battery pack falls into the locking space to prevent the extension end from exiting the locking space, so as to avoid the risk of the battery pack exiting from the bracket after the locking is completed.

The movable part prevents the extension end of the battery pack from exiting the locking space on the bracket, which realizes the stable locking of the battery pack and improves the safety of the battery pack used in electric vehicles.

Preferably, the movable part is rotatably arranged on the bracket to open or close the opening, and the movable part can be switched between a first state position and a second state position;

when the movable part is in the first state position, the movable part opens the opening, and the extension end can enter or leave the locking space;

when the movable part is in the second state position, the movable part closes the opening, and the extension end cannot enter or leave the locking space.

With the above structural arrangement, the opening and closing of the locking space can be realized by switching between the first state position and the second state position with the movable part, which simplifies the locking and unlocking operations, improves the efficiency of locking and unlocking, and realizes the purpose of efficiently unlocking or locking the battery pack on the bracket.

Preferably, the movable part is arranged on the bracket by means of a rotating shaft, and the rotating shaft is arranged on the bracket above the locking space, and the rotating shaft is arranged such that when the extension end is located in the locking space, then a horizontal distance between the center of the axis of the rotating shaft and the center of the battery pack is greater than a horizontal distance between the center of the extension end and the center of the battery pack.

With the structural arrangement of the above rotating shaft, when the extension end is in the locking space, even if the battery pack shakes on the bracket and causes the extension end of the battery pack to squeeze or hit the movable part, then the movable part cannot be switched to the first state position by a force acting on the movable part by the extension end itself, so that the movable part opens the opening, resulting in a locking failure. Therefore, when the extension end of a second unit is in the locking space, the arrangement of the structure of the above-mentioned rotating shaft enables the movable part to have a self-locking effect on the extension end, so as to effectively improve the reliability of the lock mechanism for the battery pack.

Preferably, the movable part is provided with a stopper portion, and when the movable part is in the first state position, the stopper portion opens the opening; when the movable part is in the second state position, the stopper portion closes the opening.

Through the above-mentioned structural arrangement, the stopper portion formed on the surface of the movable part is used to open or close the opening, so as to realize the purpose of unlocking or locking the battery pack from or to the bracket, and improve the stability of locking the battery pack.

Preferably, a side of the lock seat facing the battery pack is provided with a channel leading to the opening, and the channel is used for the extension end to enter the opening.

By arranging the above-mentioned channel, it is convenient to guide the extension end to accurately enter the opening.

Preferably, the lock seat is further provided with an abutting portion, and when the battery pack is locked by the lock mechanism, then the abutting portion abuts against a side wall of the battery pack.

By arranging the above-mentioned abutting portion to abut against the side wall of the battery pack, a shearing force of the battery pack on the bracket is reduced, the stability of the battery pack installed on the bracket is improved, so as to realize the positioning of the battery pack in the horizontal direction.

Preferably, when the battery pack is locked relative to the bracket, then the lock mechanism applies a vertical support force and a horizontal abutting force to the battery pack.

Through the lock mechanism, the extension end and the connected battery pack can be vertically connected and horizontally locked, so as to improve the locking stability of the lock mechanism to the battery pack and avoid relative shaking of the battery pack on the bracket.

Preferably, the lock mechanism further comprises a movable connecting rod, and the movable connecting rod is movably connected to the movable part, and the movable connecting rod drives the movable part to switch between the second state position and the first state position under the action of an external force.

By setting the movable connecting rod, the process of unlocking the battery pack is simplified, and the efficiency of unlocking the battery pack is improved, so as to achieve the purpose of unlocking the battery pack relative to the bracket.

Preferably, the lock mechanism is arranged on a side surface of the bracket, and the movable connecting rod is arranged vertically and can move up and down under the action of an external force.

By arranging the movable connecting rod, it is convenient to drive the movable connecting rod to drive the movable part to move, and the efficiency of unlocking the battery pack is improved.

Preferably, the lock mechanism further comprises a driver, the driver is used to drive the movable connecting rod to drive the movable part to switch between the second state position and the first state position, so as to actively drive the movable part to switch states.

Through the driver, the movable part is driven to switch from the second state position to the first state position, which improves the efficiency of automatic unlocking.

Preferably, when the movable connecting rod moves upward, then the movable part is switched from the second state position to the first state position, so as to control the movement of the movable part to unlock the battery pack from the bracket.

By controlling the movement of the movable part to unlock the battery pack, the unlocking process of the battery pack is simplified and the efficiency of unlocking the battery pack is improved.

Preferably, an end of the movable connecting rod protrudes downward from a lower surface of the bracket, the driver is a lift, and the lift is located below the bracket, and a lifting platform of the lift lifts up and pushes the end of the movable connecting rod to drive the movable part to move from the second state position to the first state position.

With the above structural arrangement, the lift or the stacker in the existing battery replacement devices is used to both transfer and unlock the battery, so as to further simplify the complexity of the unlocking process of the lock mechanism for the battery pack and improve the unlocking efficiency.

Preferably, the lifting platform of the lift is in contact with the lower surface of the bracket after pushing up the end of the movable connecting rod.

The purpose of lifting the bracket is further realized and the versatility of each component is improved.

Preferably, the lock mechanism further comprises an elastomer, the elastomer is connected to the movable connecting rod and is used to apply an elastic force to the movable part to keep the movable part in the second state position.

After the extension end enters the locking space, a resilient force of the elastomer drives the movable part back to the second state position to close the opening, improving the stability and safety of the battery pack locking.

Preferably, the elastomer is a tension spring, so as to improve the rebound effect of the movable part.

A lock mechanism for a battery pack, the lock mechanism is used to unlock or lock the battery pack from or to a bracket, and the lock mechanism comprises a first unit and a second unit which are respectively arranged on a side wall of the bracket and a side wall of the battery pack, the first unit comprises a lock seat which is provided with a locking space, and the second unit comprises an extension end;

when the battery pack is placed relative to the bracket, the locking space bears and locks the extension end, and the lock mechanism is provided, above the locking space, with an opening, which faces the battery pack and approaches the battery pack in a horizontal direction, such that the extension end enters the opening in a horizontal direction facing the side wall of the bracket and falls into the locking space.

The lock mechanism allows the second unit of the battery pack to pass through the opening in the horizontal direction and then fall down into the locking space, and uses the locking space to fix the extension end of the second unit, so that the battery pack can be fixed relative to the bracket in the process of being placed on the bracket by a battery replacement device such as a stacker, so as to effectively reduce the complexity of the process and cumbersome steps of installing and fixing the battery pack on the bracket, and improve the efficiency of locking of the battery pack, and also ensure the reliability of fixing the battery pack on the bracket.

Preferably, a direction in which the battery pack is unlocked relative to the bracket is opposite to a direction in which the battery pack is locked relative to the bracket;

when the battery pack is unlocked relative to the bracket, then the extension end leaves the locking space; so that the second unit is broken away from the first unit.

Preferably, a side of the lock seat facing the battery pack is provided with a channel leading to the opening, and the channel is used for the extension end to enter the opening;

the battery pack is placed on the bracket after entering the bracket along a second direction, and the second direction is the same as an extending direction of the channel.

Preferably, the second direction is a horizontal direction, so that the battery pack can be placed by the stacker and locked on the bracket.

Preferably, there are multiple lock mechanisms, and the multiple lock mechanisms are evenly distributed on rear side surfaces of the bracket and the battery pack, so as to improve the fixing ability of the lock mechanism to the battery pack.

A bracket assembly, wherein the bracket assembly comprises a bracket and the above-mentioned lock mechanism for the battery pack.

The bracket assembly, by means of the lock mechanism, allows the second unit of the battery pack to pass through the opening in the horizontal direction and then fall down into the locking space, and uses the locking space to fix the extension end of the second unit, so that the battery pack can be fixed relative to the bracket in the process of being placed on the bracket by a battery replacement device such as a stacker, so as to effectively reduce the complexity of the process and cumbersome steps of installing and fixing the battery pack on the bracket, and also ensure the reliability of fixing.

Preferably, the lock mechanism is evenly distributed on a rear side surface of the bracket.

The lock mechanism is arranged in a space at the rear side of the bracket, and the layout is reasonable; and because the lock mechanism is arranged close to an electric connection plug, the battery pack is locked on the bracket while the battery pack is electrically plugged, so that the installation efficiency of the battery pack is improved, and a relative movement of the electric connection plug and a socket on the battery pack is restricted by the lock mechanism, so that the reliability of the electrical connection interface can be improved.

Preferably, the bracket is fixed to a surface of a chassis beam of an electric vehicle by means of a fastener, so that the bracket assembly can maintain stability when installed in the electric vehicle.

A battery pack, wherein the battery pack comprises a battery pack body and the second unit of the above-mentioned lock mechanism for the battery pack.

The battery pack allows the second unit of the lock mechanism to pass through the opening in the horizontal direction and then fall down into the locking space, and uses the locking space to fix the extension end of the second unit, so that the battery pack can be fixed relative to the bracket in the process of being placed on the bracket by a battery replacement device such as a stacker, so as to effectively reduce the complexity of the process and cumbersome steps of installing and fixing the battery pack on the bracket, and also ensure the reliability of fixing.

Preferably, the second unit is evenly distributed on a rear side surface of the battery pack body, so as to utilize a space on the rear side of the battery pack to arrange the lock mechanism, and the layout is reasonable, and since the lock mechanism is located close to an electric connection plug, the electrical connection reliability may also be enhanced.

An electric vehicle comprises:

a bracket assembly;

a battery pack; the lock mechanism for the battery pack as described above.

The electric vehicle, by means of the lock mechanism, allows the second unit of the battery pack to pass through the opening in the horizontal direction and then fall down into the locking space of the bracket, and uses the locking space to fix the extension end of the second unit, so that the battery pack can be fixed relative to the bracket in the process of being placed on the bracket by a battery replacement device such as a stacker, so as to effectively reduce the complexity of the process and cumbersome steps of installing and fixing the battery pack on the bracket, and also ensure the reliability of fixing.

A lock method for a battery pack, wherein the lock method for the battery pack uses the lock mechanism for the battery pack as described above, and the lock method for the battery pack comprises the following steps:

moving the battery pack in a horizontal direction and controlling the extension end to enter the opening;

moving the battery pack in a vertical direction and controlling the extension end to enter the locking space:

controlling the lock mechanism to close the opening so as to lock the battery pack.

The positive improved effects of the present disclosure are:

In the lock mechanism for the battery pack, the bracket assembly, the battery pack, the electric vehicle and the lock method for the battery pack, the lock mechanism allows the second unit of the battery pack to pass through the opening in the horizontal direction and then fall down into the locking space, and uses the locking space to fix the extension end of the second unit, so that the battery pack can be fixed relative to the bracket in the process of being placed on the bracket by a battery replacement device such as a stacker, so as to effectively reduce the complexity of the process and cumbersome steps of installing and fixing the battery pack on the bracket, and also ensure the reliability of fixing.

### BRIEF DESCRIPTION OF THE DRAWINGS

FIG. 1 is a schematic diagram of a locked state of a battery pack and a bracket according to an embodiment of the present disclosure.

FIG. 2 is a structural diagram of a bracket assembly according to an embodiment of the present disclosure.

FIG. 3 is a structural diagram of a battery pack according to an embodiment of the present disclosure.

FIG. 4 is a structural diagram of a lock mechanism according to an embodiment of the present disclosure.

FIG. 5 is a schematic diagram (I) of the locking process of the lock mechanism according to an embodiment of the present disclosure.

FIG. 6 is a schematic diagram (II) of the locking process of the lock mechanism according to an embodiment of the present disclosure.

FIG. 7 is a schematic diagram (III) of the locking process of the lock mechanism according to an embodiment of the present disclosure.

FIG. 8 is a schematic diagram (I) of a motion state of a movable connecting rod according to an embodiment of the present disclosure.

FIG. 9 is a schematic diagram (II) of a motion state of a movable connecting rod according to an embodiment of the present disclosure.

FIG. 10 is a schematic diagram of the connection relationship between an electric vehicle and a bracket assembly according to an embodiment of the present disclosure.

Description of reference numerals:

lock mechanism 10, horizontal direction A; first unit 1, locking space la, opening lb, channel lc; movable part 11, stopper portion 11a; rotating shaft 12; lock seat 13, abutting portion 131; arched surface 132; movable connecting rod 14, end 14a; lifting platform 151; second unit 2, extension end 21; battery pack 3; bracket 4, lower surface 4a; electric connection plug 41; bracket assembly 20; electric vehicle body 5, left beam 51, right beam 52.

### DETAILED DESCRIPTION OF THE PREFERRED EMBODIMENT

The present disclosure is further illustrated below by means of examples, but the present disclosure is not limited to the scope of the examples.

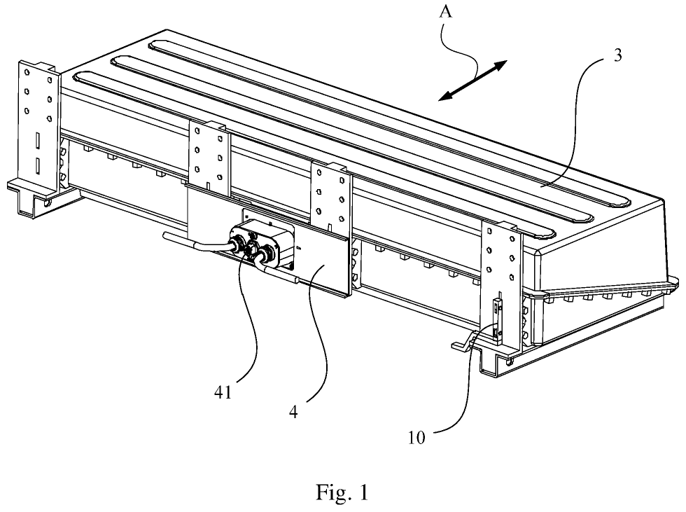

As shown in FIGS. 1-4, the present disclosure provides a lock mechanism for a battery pack for unlocking or locking a battery pack 3 from or to a bracket 4.

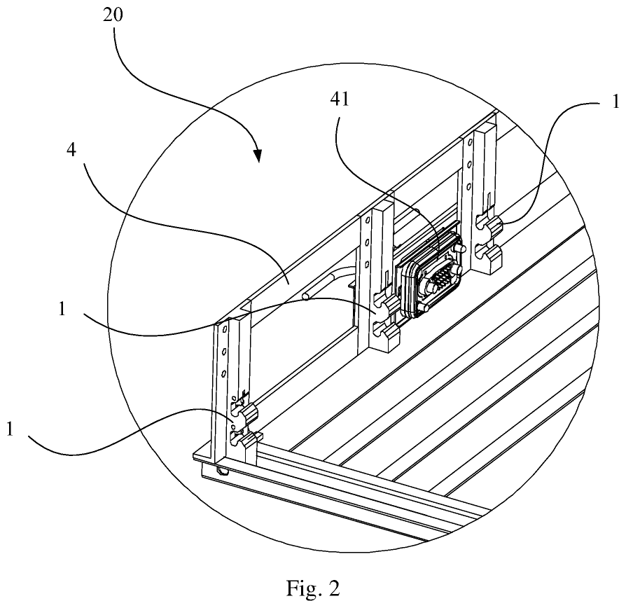

As shown in FIG. 2, the lock mechanism 10 comprises a plurality of first units 1, which are arranged on a side wall of the bracket 4 of a bracket assembly 20. In this embodiment, the first units 1 are specifically arranged on a rear side surface of an electric connection plug 41 of the bracket 4, and are evenly distributed with each other.

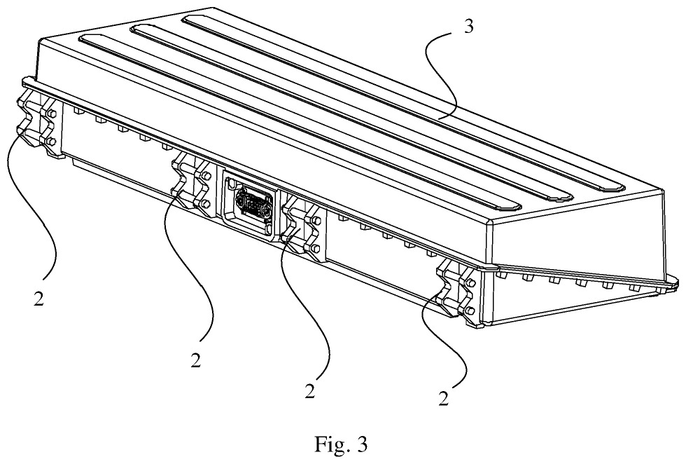

As shown in FIG. 3, the lock mechanism 10 further comprises a plurality of second units 2, which are arranged on a rear side surface of the battery pack 3 and are arranged corresponding to the positions of the first units 1. Each second unit 2 is locked in the corresponding first unit 1 to realize the locking of the battery pack 3 relative to the bracket 4.

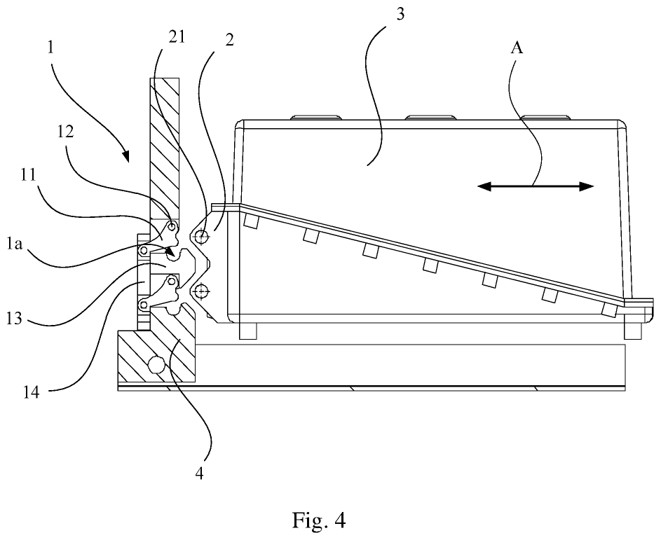

Herein, as shown in FIG. 4, the first unit 1 comprises a lock seat 13, and the lock seat 13 is provided with a locking space la for an extension end 21 of the second unit 2 to enter.

When the battery pack 3 is placed relative to the bracket 4, the locking space la of the lock seat 13 is used to bear and lock the extension end 21. As shown in FIG. 4, the lock mechanism 10 is provided, above the locking space la, with an opening lb which faces the battery pack 3 and approaches the battery pack 3 in a horizontal direction A, such that the extension end 21 of the second unit 2 can enter the opening lb along the horizontal direction A facing the side wall of the bracket 4 and fall into the locking space la.

The lock mechanism 10 allows the second unit 2 of battery pack 3 to pass through the opening 1b along the horizontal direction A and then fall down into the locking space 1a, and uses the locking space 1a to fix the extension end 21 of the second unit 2, so that the battery pack 3 can be fixed relative to the bracket 4 in the process of being placed on the locking position on the bracket 4 by a battery replacement device such as a stacker, so as to effectively reduce the complexity of the process and cumbersome steps of installing and fixing the battery pack 3 on the bracket 4, and also ensure the reliability of fixing. By setting the lock mechanism on the side wall of bracket 4, the battery pack 3 is locked in the process of moving towards the bracket 4, and the shaking of the battery pack 3 on an electric vehicle can be effectively restricted from the horizontal direction, so as to improve the stability of the battery pack 3, simplify the locking and unlocking process, and improve the efficiency of locking and unlocking the battery pack 3. By setting the opening lb approaching the battery pack 3 along the horizontal direction A, the battery pack 3 enters the locking space la on the lock seat 13 while approaching the bracket 4 without additional equipment or operation to achieve the purpose of locking and fixing the battery pack 3 on the bracket 4, simplifying the locking method and improving the efficiency of locking and installing the battery pack 3.

In this embodiment, the first units 1 and the second units 2 of the lock mechanism 10 are evenly distributed on rear side surfaces of the bracket 4 and the battery pack 3, respectively, so as to use the rear side space to arrange the lock mechanism 10 in a reasonable layout, and because the lock mechanism 10 is arranged close to the electric connection plug 41, the battery pack 3 is locked on the bracket 4 while realizing the electrical plugging of the battery pack 3, which improves the installation efficiency of the battery pack 3, and limits the relative movement of the electric connection plug 41 and a socket on the battery pack 3 by means of the lock mechanism, which also improves the reliability of the electrical connection.

As shown in FIG. 4, which is a schematic structural diagram of the lock mechanism for the battery pack in this embodiment, it can be seen from the figure that the locking space la of the first unit 1 forms in the lock seat 13, and the lock seat 13 is arranged in the surface of the bracket 4 facing the battery pack 3. The surface of the lock seat 13 is provided with an abutting portion 131, and when the battery pack 3 is locked by the lock mechanism 10, the abutting portion 131 abuts against a side wall surface of the battery pack 3, so as to realize the positioning of the battery pack 3 along the horizontal direction A. In addition, the locking space la is formed in an upward groove of the opening 1b inside the lock seat 13. When the extension end 21 enters the groove, the groove wall of the groove can vertically limit the up-and-down position of the extension end 21 relative to the lock seat, which realizes a bearing in the vertical direction, and further improves the locking stability of the lock mechanism 10 to the battery pack 3. In addition, a right side surface of the lock seat 13 is provided with a channel 1c connected to the opening 1b, and the channel 1c is used to guide the extension end 21 to enter the opening 1b along the horizontal direction A. Therefore, an arched surface 132 is provided on the lock seat 13 in the area of the channel lc for guiding the extension end 21, so that the extension end 21 enters the opening lb accurately.

It is certain that in other embodiments, the lock seat 13 may also be directly formed on the surface of the side wall of the bracket 4 where the electric connection plug 41 is arranged, that is, the locking space la is arranged inside the bracket 4, and the opening lb is opened on the surface of the bracket 4 to achieve the same effect as in this embodiment.

In addition, the first unit 1 also comprises a movable part 11. The movable part 11 is used to lock the extension end 21 after the extension end 21 enters the locking space la, so as to prevent the extension end 21 from exiting from the locking space la, and avoid the risk of the battery pack 3 coming out of the bracket 4 after the locking is completed. The movable part 11 prevents the extension end 21 on the battery pack 3 from exiting from the locking space 1a on the bracket 4, which realizes the stable locking of the battery pack 3 and improves the safety of the battery pack 3 used in electric vehicles. As shown in FIG. 4, the movable part 11 is rotatively arranged on bracket 4 with a rotating shaft 12 as a center, and the surface of the movable part 11 is provided with a stopper portion 11a. The movable part 11 can switch between a first state position and a second state positions to open or close the opening lb of lock seat 13 by means of the stopper portion 11a. When the movable part 11 is in the first state position, the stopper portion 11a opens the opening 1b, so that the extension end 21 can enter or leave the locking space la, that is, the battery pack 3 can enter the bracket 4, or be removed from the bracket 4; while when the movable part 11 is in the second state position, the stopper portion 11a closes the opening 1b, so that the extension end 21 cannot enter or leave the locking space 1a, that is, the battery pack 3 is locked on the bracket 4. Through the above structural arrangement, the movable part 11 may be used to switch between the first state position and the second state position to realize the opening and closing of the opening 1b of the locking space, which simplifies the operations of locking and unlocking, improves the efficiency of locking and unlocking, realizes the purpose of efficiently unlocking or locking the battery pack 3 from or to the bracket 4, and improves the stability of the battery pack locking.

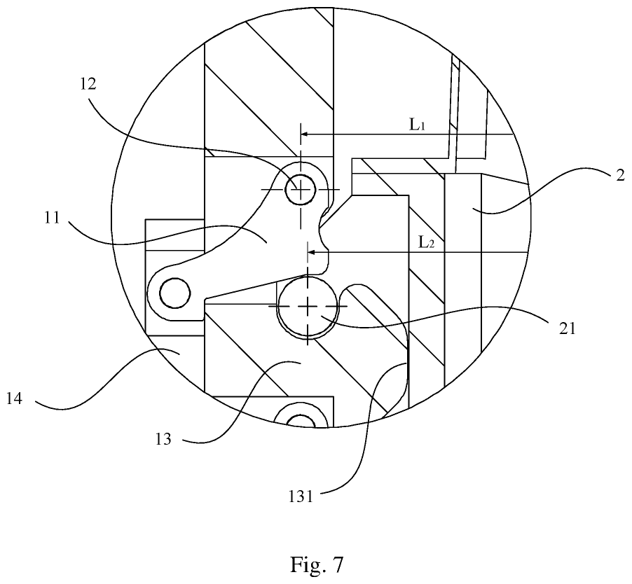

Herein, as shown in FIG. 7, FIG. 7 shows a state in which the extension end 21 is locked in the locking space 1a. The rotating shaft 12 is arranged above the locking space la, and the position of the rotating shaft 12 is specifically arranged as follows: when the extension end 21 is located in the locking space 1a, then a horizontal distance L₁ between the center of the axis of the rotating shaft 12 and the center of the battery pack 3 (not shown in the figure) is greater than a horizontal distance L₂ between the center of the extension end 21 and the center of the battery pack 3. Under this position setting, when the battery pack 3 is subjected to an external force and is about to exit from the locking space la in the vertical upward direction, the movable part 11 is in the second state position. Even if the extension end 21 abuts against the movable part 11 in the vertical upward direction, a force exerted by the extension end 21 on the movable part 11 cannot push the movable part 11 to the first state position. That is to say, under the setting of the structure of the rotating shaft 12, when the extension end 21 is in the locking space 1a, even if the battery pack 3 shakes on the bracket 4 and causes the extension end 21 of the battery pack 3 to squeeze or hit the movable part 11, the movable part 11 cannot be switched to the first state position by the force acting on the movable part 11 by the extension end 21 itself, so that the movable part 11 opens the opening 1b, resulting in a locking failure. Therefore, when the extension end 21 is in the locking space 1a, the setting of the structure of the rotating shaft 12 enables the movable part 11 to have a self-locking effect on the extension end 21, so as to effectively improve the reliability of the lock mechanism for the battery pack.

The first unit 1 also comprises a movable connecting rod 14 and a driver. The movable connecting rod 14 is movably connected to the movable part 11 to drive the movable part 11 to switch between the second state position and the first state position under the action of an external force, which simplifies the process of unlocking the battery pack 3 and improves the efficiency of unlocking the battery pack 3 to achieve the purpose of unlocking the battery pack 3 relative to the bracket 4. In this embodiment, the external force may come from a driver, and the driver is used to drive the movable connecting rod 14 to drive the movable part 11 to switch between the second state position and the first state position, so as to actively drive the movable part 11 to switch states. Through the driver, the movable part 11 is driven to switch from the second state position to the first state position, which improves the efficiency of automatic unlocking.

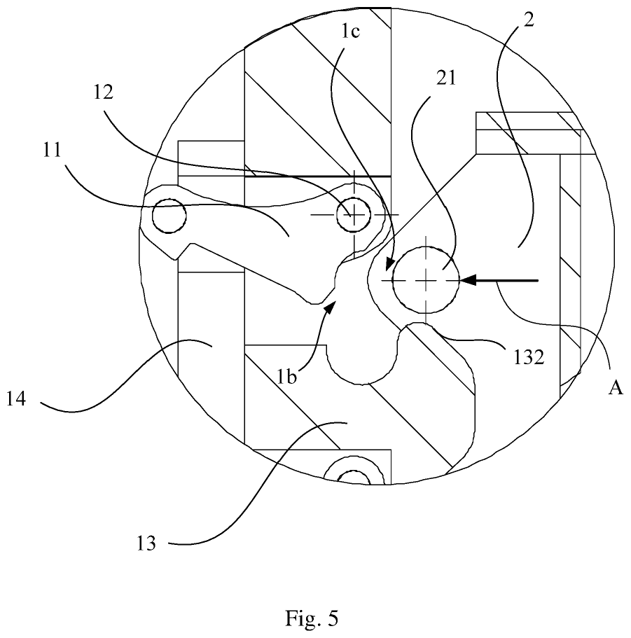

In this embodiment, as shown in FIGS. 5-7, it is the switching process of the position and state of the movable part 11 when the battery pack 3 enters the bracket 4. As shown in FIG. 5, when the battery pack 3 enters the bracket 4 along the horizontal direction A under the action of the stacker or other battery replacement devices, the extension end 21 of the second unit 2 of the battery pack 3 enters the interior of the lock seat 13 from the channel 1c, and moves to the position of the opening 1b. At this time, the movable part 11 is required to be in the first position, so that the extension end 21 can enter the opening 1b smoothly. In the process of the extension end 21 entering the channel 1c along the horizontal direction A, the extension end 21 pushes the movable part 11 to move to the first position to open the opening lb. In other embodiments, the movable connecting rod 14 may also be moved upward by means of an external force, driving the movable part 11 to move to the first state position to open the opening 1b.

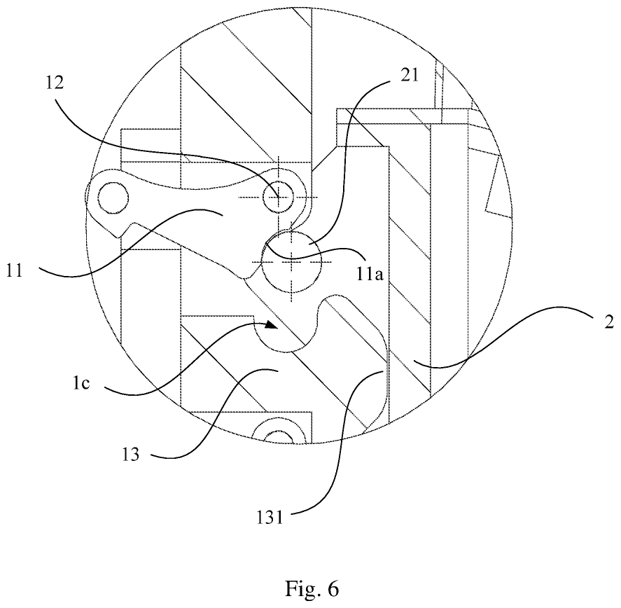

Afterwards, as shown in FIG. 6, when the extension end 21 reaches the opening lb above the locking space 1a, a force applied to the battery pack 3 moving in the horizontal direction A is stopped, and after the extension end 21 enters the opening lb, the battery pack 3 is moved downward in the vertical direction and placed on the surface of a bearing part of the bracket 4 at the bottom. At the same time, the extension end 21 falls into the locking space 1a inside the lock seat 13 in the vertical downward direction, so as to utilize the locking space 1a to limit the extension end 21 from moving in other directions except the vertical upward direction. At this time, it can be seen from the figure that when the extension end 21 is located in the locking space 1a, the surface of a side of the lock seat 13 facing the battery pack 3 abuts against the side wall of the battery pack 3, so that the battery pack 3 is locked on the bracket 4, the purpose of positioning the battery pack 3 along the horizontal direction A is achieved by utilizing a horizontal abutting force of the lock seat 13 against the battery pack 3.

Finally, as shown in FIG. 7, when the extension end 21 reaches the groove of the locking space 1a, the movable part 11 turns over under the action of the movable connecting rod 14 to return to the second state position, and closes the opening lb by means of the stopper portion 11 a of the movable part 11, so as to limit the extension end 21 from moving upward and from leaving the locking space 1a to achieve locking of the battery pack 3 relative to the bracket 4.

In this embodiment, when the battery pack 3 needs to be unlocked relative to the bracket 4, it is necessary to switch the movable part 11 from the second state position back to the first state position, and move the battery pack 3 along a path opposite to a moving path when locked. The specific unlocking process is completely opposite to the locking process of the lock mechanism 10, so it will not be repeated here.

Herein, it can be seen from FIG. 5-Fig. 7 that the movable connecting rod 14 in this embodiment moves along the vertical direction, so that the movable part 11 is switched between the first state position and the second state position. Specifically, when the movable connecting rod 14 moves upward, then the movable part 11 switches to the first state position, and the opening 1b is opened, and when the movable connecting rod 14 moves downward, then the movable part 11 switches to the second state position, and the opening 1b is closed. Herein, the downward movement of the movable connecting rod 14 can be realized by relying on its own gravity, and after the movable part 11 is switched to the second state position, the extension end 21 located in the locking space la cannot push the movable part 11 upward to the first state position due to self-locking, so the reliability can also be guaranteed.

That is, the driver in this embodiment only needs to drive the movable connecting rod 14 to move upwards for controlling the movement of the movable part 11 to unlock the battery pack 3 from the bracket 4.

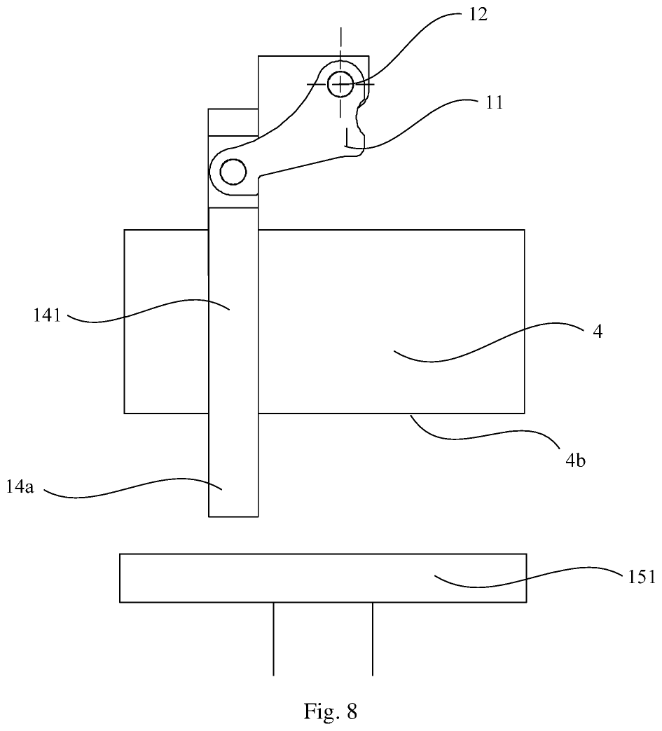

Therefore, this embodiment provides a more preferable solution that enables the driver to drive the movable connecting rod 14 to move upward. As shown in FIG. 8, an end of the movable connecting rod 14 protrudes downward from the lower surface 4aof the bracket 4, and the driver is specifically a lift or a stacker. The driver is located below the bracket 4, and the lifting platform 151 of the driver lifts upwards and pushes the end of the movable connecting rod 14 to drive the movable part 11 to move from the second state position to the first state position. The lock mechanism 10 drives the movable part 11 to switch states by using a lift or a stacker as a driver, so as to use the existing battery replacement devices to have the functions of battery transferring and unlocking, so as to further simplify the complexity of the unlocking process of the lock mechanism 10.

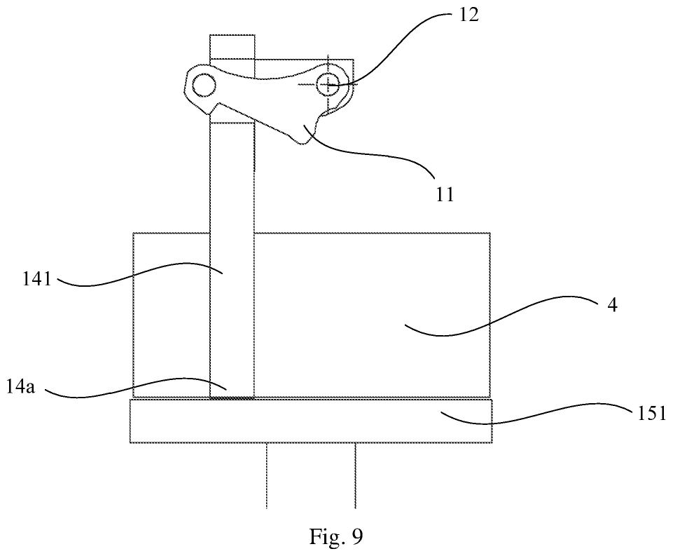

As shown in FIG. 9, after the lifting platform 151 pushes the end of the movable connecting rod 14 upwards, the lifting platform 151 also continues to rise, and contacts with the lower surface 4a of the bracket 4, so as to further realize the purpose of lifting the bracket 4 (and the electric vehicle connected to the bracket 4).

It is certain that in other embodiments, instead of using the gravity of the movable connecting rod 14 to drive the movable connecting rod 14 to move, an elastomer (not shown in the figure) is connected to the movable connecting rod 14 and used to apply an elastic force to the movable connecting rod 14 to replace the gravity to keep the movable connecting rod 14 and the movable part 11 in a certain position without other external forces. Preferably, the elastomer may be a tension spring, so as to improve the rebound effect of the movable part 11. One end of the elastomer is connected to the movable connecting rod 14, and the other end is connected to the bracket 4.

In this embodiment, at least two first units 1 are arranged on the bracket 4 along the vertical direction, so as to improve the bearing capacity of the bracket 4 to the battery pack 3, and a plurality of first units 1 are evenly arranged on both sides of the electric connection plug along the horizontal direction A to lock the battery pack 3, so as to improve the bearing capacity and control uniform stress.

The second unit 2 comprises an extension end 21 and a mounting base, and the extension end 21 is installed on the side wall of the battery pack 3 by means of the mounting base. The extension end 21 may be a locking bar, a locking block, a locking plate or other structures that can enter the locking space to realize the locking of the battery pack. The extension end 21 may be fixedly mounted on the mounting base, or may rotate relative to the mounting base, which reduces friction during the locking process. In this embodiment, at least two second units 2 are arranged on the battery pack 3 along the vertical direction to improve the firmness of the connection of the battery pack 3 relative to the bracket 4, and a plurality of second units 2 may also be evenly arranged on both sides of the electric connection plug along the horizontal direction A for connecting the first units 1 on the bracket 4, so as to improve bearing capacity and control uniform stress.

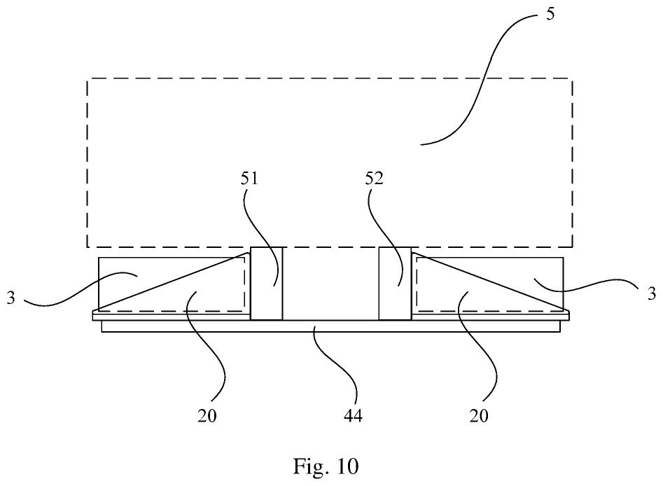

The present disclosure also provides an electric vehicle, which uses the bracket assembly 20, the battery pack 3 and the lock mechanism 10 as described above. As shown in FIG. 10, an electric vehicle body 5 is provided with a chassis underneath, and a chassis beam is divided into a left beam 51 and a right beam 52 which are arranged in parallel. Two bracket assemblies 20 are arranged on the outside of the left beam 51 and the right beam 52 respectively, and the opening lb is outward for the battery pack 3 to be mounted on the lower part of the vehicle body from both sides. The bracket assembly 20 is fixed to the chassis by means of a fastener, so as to ensure the stability of the bracket assembly 20 when installed in the electric vehicle, and avoid vibration of the bracket assembly 20 when the electric vehicle is running.

In addition, bottom plate crossbeams of the brackets 4 of the two bracket assemblies 20 are integrally formed, and the bottom plate crossbeams are fixed on the lower side surfaces of the left beam 51 and the right beam 52 to further improve the mounting stability of the bracket assembly 20.

The present disclosure also provides a lock method for a battery pack:

1. moving the battery pack 3 in a horizontal direction A and controlling the extension end 21 to enter the opening. Specifically, the battery pack 3 may be moved along the horizontal direction A to approach the bracket 4 by means of a battery replacement device and the movable part 11 may be pushed toward the first state position by the extension end 21 to open the opening 1b, so that the extension end 21 can enter the opening lb.

2. moving the battery pack 3 in a vertical direction and control the extension end 21 to enter the locking space 1a. Specifically, the battery pack 3 is moved vertically downward by means of the battery replacement device, so that the extension end 21 enters the locking space la, and is born in a groove that forms the locking space la.

3. controlling the lock mechanism to close the opening to lock the battery pack 3, so that the battery pack 3 is locked on the bracket 4. Specifically, when the extension end 21 of the battery pack 3 reaches the locking space la, the movable part 11 rotates to the second state position under the action of the movable connecting rod 14 to close the opening 1b.

It is certain that in other embodiments, before the extension end 21 enters the opening lb, a battery replacement device can be used to apply a force to the movable connecting rod 14, so as to drive the movable part 11 to open the opening lb by the force applied by the battery replacement device.

Although the specific implementation of the present disclosure has been described above, those skilled in the art should understand that this is only an example, and the protection scope of the present disclosure is defined by the appended claims. Those skilled in the art can make various changes or modifications to these embodiments without departing from the principle and essence of the present disclosure, but these changes and modifications all fall within the protection scope of the present disclosure.

1. A lock mechanism for a battery pack, wherein the lock mechanism is arranged on a side wall of a bracket, the lock mechanism is used to unlock or lock the battery pack from or to the bracket, the lock mechanism comprises a lock seat, the lock seat is provided with a locking space, the lock mechanism is used to bear an extension end, when the extension end on the battery pack, the battery pack is placed relative to the bracket, and lock the extension end in the locking space;
the lock mechanism is provided, above the locking space, with an opening which faces the battery pack and approaches the battery pack in a horizontal direction, such that the extension end enters the opening in a horizontal direction facing the side wall of the bracket and falls into the locking space.

2. The lock mechanism for the battery pack as claimed in claim 1, wherein the lock mechanism further comprises a movable part, and the movable part is used to lock the extension end after the extension end of the battery pack falls into the locking space to prevent the extension end from exiting the locking space.

3. The lock mechanism for the battery pack as claimed in claim 2, wherein the movable part is rotatably arranged on the bracket to open or close the opening, and the movable part can be switched between a first state position and a second state position;
when the movable part is in the first state position, the movable part opens the opening, and the extension end can enter or leave the locking space;
when the movable part is in the second state position, the movable part closes the opening, and the extension end cannot enter or leave the locking space.

4. The lock mechanism for the battery pack as claimed in claim 3, wherein the movable part is arranged on the bracket by means of a rotating shaft, and the rotating shaft is arranged on the bracket above the locking space, and the rotating shaft is arranged such that when the extension end is located in the locking space, a horizontal distance between the center of the axis of the rotating shaft and the center of the battery pack is greater than a horizontal distance between the center of the extension end and the center of the battery pack.

5. The lock mechanism for the battery pack as claimed in claim 3, wherein the movable part is provided with a stopper portion, and when the movable part is in the first state position, the stopper portion opens the opening; when the movable part is in the second state position, the stopper portion closes the opening;
and/or, a side of the lock seat facing the battery pack is provided with a channel leading to the opening, and the channel is used for the extension end to enter the opening.

6. The lock mechanism for the battery pack as claimed claim 1, wherein the lock seat is further provided with an abutting portion, and when the battery pack is locked by the lock mechanism, the abutting portion abuts against a side wall of the battery pack;
and/or, when the battery pack is locked relative to the bracket, the lock mechanism applies a vertical support force and a horizontal abutting force to the battery pack.

7. The lock mechanism for the battery pack as claimed in claim 1, wherein the lock mechanism further comprises a movable connecting rod, and the movable connecting rod is movably connected to the movable part, and the movable connecting rod drives the movable part to switch between the second state position and the first state position under the action of an external force.

8. The lock mechanism for the battery pack as claimed in claim 5, wherein the lock mechanism is arranged on a side surface of the bracket, and the movable connecting rod is arranged vertically and can move up and down under the action of an external force;
preferably, the lock mechanism further comprises a driver, the driver is used to drive the movable connecting rod to drive the movable part to switch between the second state position and the first state position.

9. The lock mechanism for the battery pack as claimed in claim 8, wherein when the movable connecting rod moves upward, the movable part is switched from the second state position to the first state position.

10. The lock mechanism for the battery pack as claimed in claim 9, wherein an end of the movable connecting rod protrudes downward from a lower surface of the bracket, the driver is a lift, and the lift is located below the bracket, and a lifting platform of the lift lifts up and pushes the end of the movable connecting rod so as to drive the movable part to move from the second state position to the first state position.

11. The lock mechanism for the battery pack as claimed in claim 10, wherein the lifting platform of the lift is in contact with the lower surface of the bracket after pushing up the end of the movable connecting rod.

12. The lock mechanism for the battery pack as claimed in claim 5, wherein the lock mechanism further comprises an elastomer, the elastomer is connected to the movable connecting rod and is used to apply an elastic force to the movable part to keep the movable part in the second state position;
preferably, the elastomer is a tension spring.

13. A lock mechanism for a battery pack, wherein the lock mechanism is used to unlock or lock the battery pack from or to a bracket, and the lock mechanism comprises a first unit and a second unit which are respectively arranged on a side wall of the bracket and a side wall of the battery pack, the first unit comprises a lock seat which is provided with a locking space, and the second unit comprises an extension end;
when the battery pack is placed relative to the bracket, the locking space bears and locks the extension end, and the lock mechanism is provided, above the locking space, with an opening, which faces the battery pack and approaches the battery pack in a horizontal direction, such that the extension end enters the opening in a horizontal direction facing the side wall of the bracket and falls into the locking space.

14. The lock mechanism for the battery pack as claimed in claim 13, wherein a direction in which the battery pack is unlocked relative to the bracket is opposite to a direction in which the battery pack is locked relative to the bracket;
when the battery pack is unlocked relative to the bracket, the extension end leaves the locking space;
and/or, a side of the lock seat facing the battery pack is provided with a channel leading to the opening, and the channel is used for the extension end to enter the opening;
the battery pack is placed on the bracket after entering the bracket along a second direction, and the second direction is the same as an extending direction of the channel;
and/or, the second direction is a horizontal direction;
and/or, there are multiple lock mechanisms, and the multiple lock mechanisms are evenly distributed on rear side surfaces of the bracket and the battery pack.

15. A bracket assembly, wherein the bracket assembly comprises a bracket and the lock mechanism for the battery pack as claimed in claim 1.

16. The bracket assembly as claimed in claim 15, wherein the lock mechanism is evenly distributed on a rear side surface of the bracket;
and/or, the bracket is fixed to a surface of a chassis beam of an electric vehicle by means of a fastener.

17. A battery pack, wherein the battery pack comprises a battery pack body and the second unit of the lock mechanism for the battery pack as claimed in claim 13.

18. The battery pack as claimed in claim 17, wherein the second unit is evenly distributed on a rear side surface of the battery pack body.

19. An electric vehicle, wherein the electric vehicle comprises:
a bracket assembly;
a battery pack;
the lock mechanism for the battery pack as claimed in claim 1.

20. A lock method for a battery pack, wherein the lock method for the battery pack uses the lock mechanism for the battery pack as claimed in claim 1, and the lock method for the battery pack comprises the following steps:
moving the battery pack in a horizontal direction and controlling the extension end to enter the opening;
moving the battery pack in a vertical direction and controlling the extension end to enter the locking space; and
controlling the lock mechanism to close the opening so as to lock the battery pack.
